(19) United States
(12) Patent Application Publication
(10) Pub. No.: US 2017/0315801 A1
(43) Pub. Date: Nov. 2, 2017

(54) PROJECT BASED STORAGE PROVISIONING WITHIN INTEGRATED DEVELOPMENT ENVIRONMENTS

(71) Applicant: NetApp, Inc., Sunnyvale, CA (US)

(72) Inventors: John Keith Fullbright, Evans, GA (US); Robert Lee Barker, JR., Santa Clara, CA (US); Mark Duane Beaupre, Los Gatos, CA (US); Nilesh PradeepKumar Maheshwari, Mountain View, CA (US)

(21) Appl. No.: 15/141,642

(22) Filed: Apr. 28, 2016

(51) Int. Cl. G06F 9/44; G06F 9/50

(52) U.S. Cl. CPC G06F 8/70; G06F 8/30; G06F 9/5016

(57) ABSTRACT

A project is created in an Integrated Development Environment (IDE) having storage management, wherein the project is associated with at least one developer to develop code artifacts in the project. Allocation, using the storage management of the IDE, is requested of storage for data created in the project during the development of the code artifacts by a plurality of tools of the IDE. Tracking data is maintained within the IDE that tracks a plurality of storage related requests by the plurality of tools of the IDE.

### BACKGROUND

The disclosure generally relates to the field of computer storage, and more particularly to project based storage provisioning within Integrated Development Environment (IDE).

An IDE is an application that provides an environment that includes access to a number of applications, resources, etc. that assist a software developer or programmer to develop various software components (e.g., source code artifacts). For example, an IDE can provide a source code editor, a debugger, a compiler, shared library resources, etc. With the advent of cloud-based storage, many software developers are leveraging resources from various service providers that include virtualized software services, infrastructure services, cloud storage and on premise assets. Individual or teams of developers manage all of these resources from the various management interfaces provided by the service providers. These management interfaces include windows-based applications, web interfaces, command line, etc. Such management results in “swivel chair development” requiring the need to move from interface to interface to manage a complex array of assets to in the development of software. Valuable time is lost by having to learn, navigate and manage individual tasks using this paradigm. Additionally, context can be lost in the larger schema of a software development project using this paradigm.

### BRIEF DESCRIPTION OF THE DRAWINGS

Embodiments of the disclosure may be better understood by referencing the accompanying drawings.

FIG. 1 depicts an example system providing an IDE with a project type with storage management and illustrating allocating storage for use during development of code artifacts within the IDE, according to some embodiments.

FIG. 2 depicts the example system of FIG. 1 illustrating reading and writing of data to the allocated storage during development of code artifacts within the IDE, according to some embodiments.

FIG. 3 depicts an example system providing an IDE with a project type with storage management and illustrating multiple developers accessing a same allocated storage during development of code artifacts within the IDE, according to some embodiments.

FIG. 4 depicts an example system illustrating multiple IDEs, wherein each IDE has an associated allocated storage provisioned by storage management in a project of the IDEs, according to some embodiments.

FIG. 5 depicts an example system illustrating one developer having multiple projects stored in different pools of storages associated with the developer, according to some embodiments.

FIG. 6 depicts a flowchart of operations for storage management within an IDE, according to some embodiments.

FIG. 7 depicts an example computer device, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to source code development in illustrative examples. But aspects of this disclosure can be applied to any type of code (e.g., assembly). In other instances, well-known instruction instances, protocols, structures and techniques have not been shown in detail in order not to obfuscate the description.

### Overview

Some embodiments relate to an Integrated Development Environment (IDE) in which various tools (such as source code editors, compilers, debuggers, etc.) and assets (source files, references, assemblies, etc.) assist a software developer during their development of artifacts (e.g., software code, applications, graphics, etc.). An IDE can include different project types that are selectable by developers. The different project types include different tools, assets, etc. Thus, a developer can select a project type for their particular project depending on the type of code being developed, assets and tools needed, etc. For example, a first project may require compiler X and debugger Y along with a first group of shared library resources, while a second project may require compiler Z and source code editor K with a second group of shared library resources.

According to some embodiments, storage management functionality is incorporated into a project type that allows for the provision of storage for the software project within the IDE. In other words, functionality within the project of the IDE is used to provision or allocate storage for the project. This provisioned storage can be used to store data produced or used in the project (e.g., source code, executables, debug outputs, shared library resources, etc.). Therefore, storage management functionality in such a project allows a developer to provision storage as part of the project. The storage can be disk storage devices, solid state storage devices, a file server communicatively coupled over a network, a cloud-based storage, local storage, etc. Storage management functionality can also be an add-on, extension, plug-in, etc. to the IDE.

Such embodiments are in contrast to conventional approaches in which developers are required to provision storage outside the IDE. For example, using a conventional approach, a developer may be required to use applications that are separate from the IDE to request storage for different parts of their project. To illustrate, a first storage is used to store source code written by a developer, a second storage is used to store output from debugging, a third storage is used to store executables output from a compiler, etc. In contrast, some embodiments integrate functionality into the IDE to allow the developer to provision storage therein to be used during development of the project. Such projects can be particularly useful for projects that include multiple developers that are concurrently developing code for the project.

### Terminology

This description uses the term “artifacts” to refer to any type of data that is created, derived, or generated within a project of an IDE. For example, an artifact can include source code written by a source code developer. An artifact can also be an executable or assembly code generated from source code compilation. Other examples of artifacts include debug output from a debugger produced during debug operations of the code. Artifacts can also include any graphics, database diagrams, etc. generated by tools in the IDE related to code development.

This description uses the term “assets” to refer to any type of data that is used to create artifacts in the project of an IDE. For example, assets can include shared library resources, assemblies, etc. that can be linked with developed source code to create an executable.

This description uses the term “project” to refer to a grouping of tools, assets, etc. within an IDE that is used in the development of artifacts by one or more developers. Each project can be derived from a particular project type having certain tools, assets, etc. Also, each project can be associated with one or more developers. As further described below, a project can include storage management functionality to allow for the provisioning of storage within the IDE. The provisioned storage can be allocated from a pool of storage assigned to the one or more developers associated with the project.

Additionally, this description uses shorthand terms related to cloud technology for efficiency and ease of explanation. When referring to “a cloud system,” this description is referring to the resources of a cloud service provider. For instance, a cloud system or cloud can encompass the servers, virtual machines, and storage devices of a cloud service provider. A device of a cloud refers to an entity that has a network address that can be used as an endpoint for a network connection. The entity may be a physical device (e.g., a server) or may be a virtual entity (e.g., virtual server or virtual storage device).

### System Architecture Examples

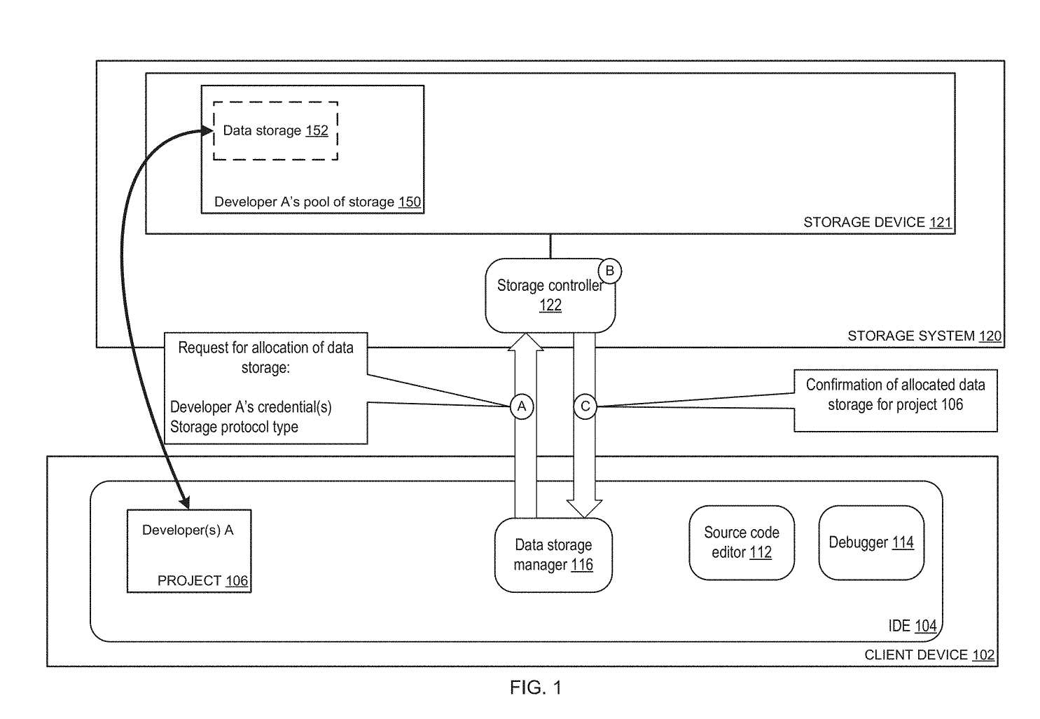

Different system architecture examples that include IDE projects with storage management are now described. FIG. 1 depicts an example system providing an IDE with a project type with storage management and illustrating allocating storage for use during development of code artifacts within the IDE, according to some embodiments. The system includes a client device 102 that is communicatively coupled to a storage system 120.

The client device 102 includes an IDE 104 that can be an application that provides an environment to assist a software developer during their development of software artifacts (e.g., software code, applications, etc.). The IDE 104 can include different tools. In this example, the IDE 104 includes a source code editor 112, a debugger 114, and a data storage manager 116. The storage manager 116 is a logical construct to represent the program code that implements the storage management functionality. The storage manager 116 may be part of the program code for the IDE, may be an add-on, extension, plug-in, etc. The IDE 104 can include other types of tools including compilers, interpreters, etc. In contrast to conventional approaches, the IDE 104 includes the data storage manager 116 that provides storage management functionality within the IDE.

The IDE 104 includes a project 106 that can be instantiated from one of a number of project types. A software developer can select one of the project types when creating a project in their IDE. Different project types can include different tools and assets depending on the type of software being created in the IDE. In this example, a developer A instantiates the project 106 from a project type that includes storage management, source code editing, and a debugger.

The storage system 120 includes a storage controller 122 to access data from a storage device 121. The storage system 120 can be a cloud-based storage, a network attached storage (NAS), a direct-attach storage (DAS), a storage area network (SAN), etc.

The storage device 121 includes a pool of storage that has been previously allocated to developer A—developer A's pool of storage 150. For example, a system administrator can allocate different portions of storages to different users or groups of users. There can also be different storage systems. For example, the system can include a cloud-based storage system, a NAS-based storage system, DAS-based storage systems, etc. Therefore, the system administrator can allocate different sizes of pools of storage, which storage system from which to allocate the pool of storage, etc. to different users and groups of users.

FIG. 1 is annotated with a series of letters A-C. These letters represent stages of operations, with each stage representing one or more operations. Although these stages are ordered for this example, the stages illustrate one example to aid in understanding this disclosure and should not be used to limit the claims. Subject matter falling within the scope of the claims can vary with respect to the order and some of the operations.

At stage A, the data storage manager 116 requests allocation of data storage for the project 106. This request can be made in response to creating the project 106. For example, the developer A can create the project 106 using a Graphical User Interface (GUI) for the IDE 104. In this example, the project 106 is of a project type that provides for storage management from within the IDE 104. The request can include the credential(s) of developer A (e.g., username, password, etc.) and the type of storage protocol to be used when reading or writing data to the developer A's pool of storage 150. The credential(s) of developer A and the type of storage protocol can be input by the developer A. The type of storage protocol is the type of protocol that is to be used when reading from or writing to the developer A's pool of storage 150. The type of storage protocol can include internet small computer system interface (iSCSI), SCSI, Hypertext Transfer Protocol (HTTP) REST protocols, etc. The request can also include an identification of the project so that the allocated storage is associated with the project.

At stage B, in response to the request, the storage controller 122 validates the credential(s) of developer A. After validation, the storage controller 122 locates the developer A's pool of storage 150 within the storage device 121. The storage controller 122 then allocates data storage 152 to store data related to the project 106. For example, data stored in the data storage 152 can include source code created by the developer A using the source code editor 112, debug output from the debugger 114 during debug operations of the source code, assemblies, database diagrams, etc.

At stage C, after validation and allocation of the pool of storage, the storage controller 122 transmits a confirmation (back to the data storage manager 116) that the data storage has been allocated to the project 106.

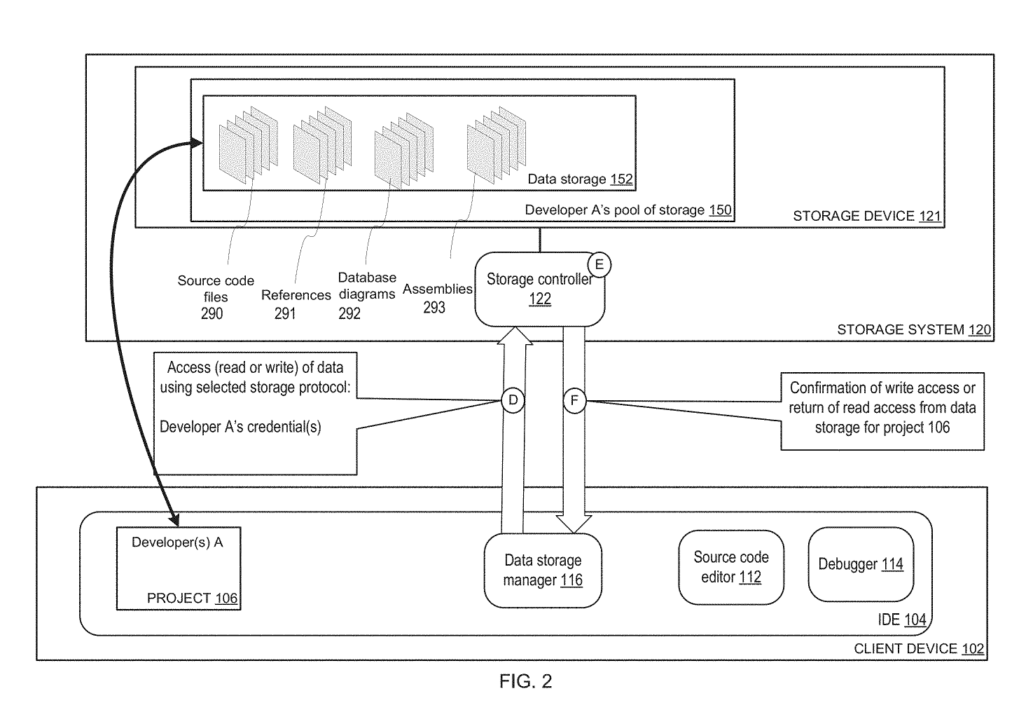

FIG. 2 depicts the example system of FIG. 1 illustrating reading and writing of data to the allocated storage during development of code artifacts within the IDE, according to some embodiments. FIG. 2 includes the components in the example system of FIG. 1.

As shown, the data storage 152 is storing different types of data for the project 106. In this example, the data storage 152 stores source code files 290, references 291, database diagrams 292, and assemblies 293. Some data (e.g., the source code files 290) can be generated based on input from the developer A. For example, the developer A can input source code into the source code editor 112 that can be stored in the data storage 152. Other data (e.g., the assemblies 293) can be generated by tools in the IDE 104. For example, a compiler (not shown) can generate an assembly by compiling source code. Other data (e.g., the references 291) can be pre-existing code that can be linked with source code created in the project 106 during its compilation.

FIG. 2 is annotated with a series of letters D-F. These letters represent stages of operations, with each stage representing one or more operations. Although these stages are ordered for this example, the stages illustrate one example to aid in understanding this disclosure and should not be used to limit the claims. Subject matter falling within the scope of the claims can vary with respect to the order and some of the operations.

At stage D, the data storage manager 116 performs access of data using the selected storage protocol from the data storage 152 (see stage A in FIG. 1 for selection of storage protocol). The access can be read or write of data related to the project 106. In addition to the data to be accessed, the data storage manager 116 includes the credential(s) of the developer A. For example, the data storage manager 116 can write data in response to a request from another one of the tools in the IDE 104. To illustrate, the source code editor 112 may receive input to save edits to a source code file from the developer A. In response, the source code editor 112 can transmit a request to the data storage manager 116 to store the edits to the source code file in the data storage 152. In another example, the data storage manager 116 can read data in response to a request from another one of the tools. To illustrate, the debugger 114 in the IDE 104 can retrieve a source code file to be debugged.

At stage E, in response to receiving the access request, the storage controller 122 validates the credential(s) of developer A. After validation, the storage controller 122 locates the data storage 152 that is associated with the project 106. This transmission to write can also include identification of the project 106. Thus, the storage controller 122 can locate the data storage 152 based on the identification of the project 106. The storage controller 122 can then access (read or write) the data in the data storage 152. If the access is a read request, the storage controller 122 can retrieve the data from the data storage 152.

At stage F, the storage controller 122 returns (back to the data storage manager 116) either a confirmation that the write access was correctly performed or the data from a read access. The data storage manager 116 can then provide the confirmation or data to the tool in the IDE 104 that originated the access request. For example, if the source code editor 112 issues a read to access a source code file stored in the data storage 152, the data storage manager 116 can return the source code file to the source code editor 112.

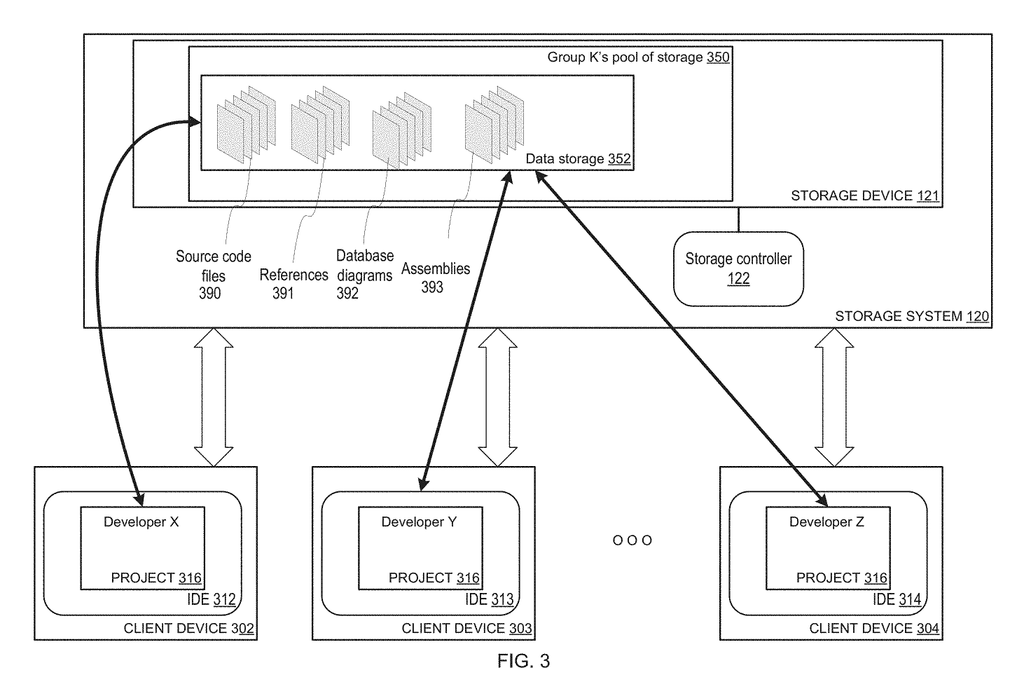

FIG. 3 depicts an example system providing an IDE with a project type with storage management and illustrating multiple developers accessing a same allocated storage during development of code artifacts within the IDE, according to some embodiments. The system includes multiple client devices (a client device 302, a client device 303, and a client device 304) that are communicatively coupled to the storage system 120.

Each client device includes an instantiation of an IDE. The client device 302 includes an IDE 312. The client device 303 includes an IDE 313. The client device 304 includes an IDE 314. Also, each IDE includes an instantiation of a same project so that multiple developers can currently access data related to the project. Each of the IDEs 312-314 include an instantiation of a project 316. The IDEs 312-314 can include tools (not shown) similar to the IDE 104 depicted in FIGS. 1-2. Also not shown, the IDEs 312-314 include a data storage manager to allow for access of data from a storage device within the IDE (as described above).

In this example, a developer X is developing code for the project 316 in the IDE 312 on the client device 302. A developer Y is developing code for the project 316 in the IDE 313 on the client device 303. A developer Z is developing code for the project 316 in the IDE 314 on the client device 304.

The storage system 120 includes the storage controller 122 to access data from the storage device 121. The storage device 121 includes a pool of storage that has been previously allocated to a group of developers—group K's pool of storage 350. Similar to the pool of storage for an individual, a system administrator can allocate different portions of storage to groups of users.

Similar to the data storage 152, the data storage 352 is storing different types of data for the project 316. In this example, the data storage 352 stores source code files 390, references 391, database diagrams 392, and assemblies 393.

As shown, each of the instantiated IDEs on the different client devices 302-304 are associated with the same allocated storage—the data storage 352. Also, each of the developers can share a group credential for accessing the data storage 352. For example, the developers X-Z can be part of a same development group for development of code for a particular project. Each developer can be tasked with creating source code for different parts of the project. Therefore, the resources can be shared among the different developers using the same allocated storage. One of the developers can be tasked with allocating the data storage 352 to the project 316 (similar to the operations depicted in FIG. 1). Then, the different developers can concurrently access the data storage during code development. Other individuals can be part of the project. For example, integrated testers and system testers can be part of the project 316. These testers can then access the data storage 352 using the same credential used by the developers. For example, the testers can retrieve from the data storage 352 different versions of executables created by the developers to test for proper functionality.

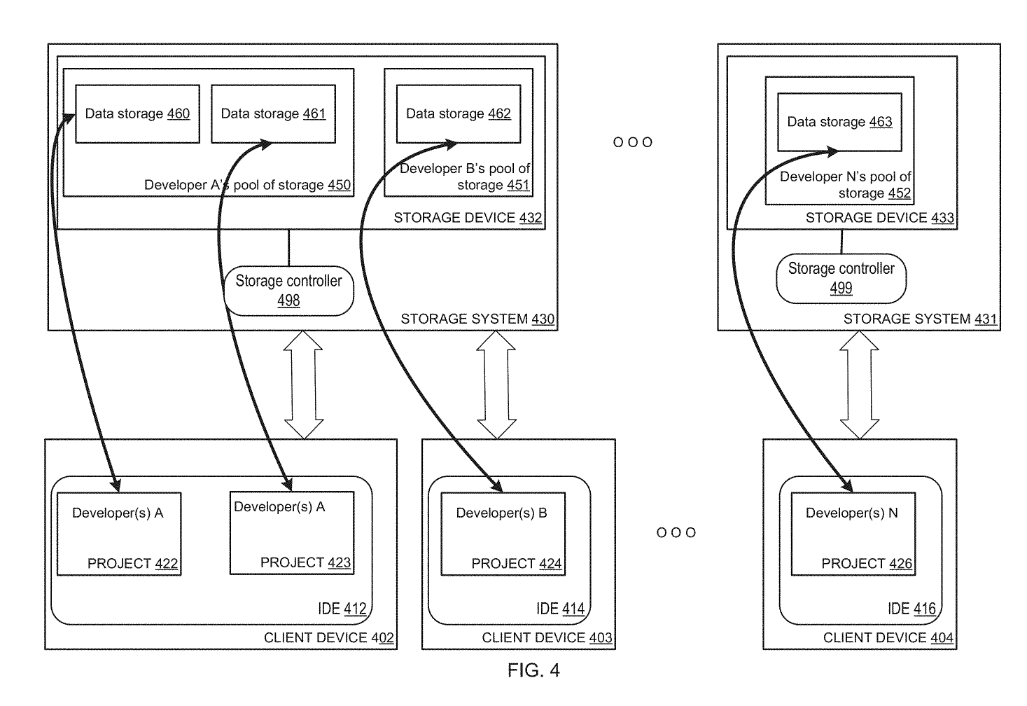

FIG. 4 depicts an example system illustrating multiple IDEs, wherein each IDE has an associated allocated storage provisioned by storage management in a project of the IDEs, according to some embodiments. In this example, there can be multiple developers having one or more projects. Additionally, in this example, the system includes multiple storage systems. For example, one storage system can be cloud-based storage, while a different storage system can be NAS. The system includes multiple client devices (a client device 402, a client device 403, and a client device 404). The client device 402 and the client device 403 are communicatively coupled to a storage system 430. The client device 404 is communicatively coupled to a storage system 431.

The storage system 430 includes a storage controller 498 that accesses data from a storage device 432. The storage system 431 includes a storage controller 499 that accesses data from a storage device 433. The storage device 432 includes a pool of storage that has been previously allocated to developer A (developer A's pool of storage 450) and a pool of storage that has been previously allocated to developer B (developer B's pool of storage 451). The storage device 433 includes a pool of storage that has been previously allocated to developer N (developer N's pool of storage 452).

Each client device includes an instantiation of an IDE. The client device 402 includes an IDE 412. The client device 403 includes an IDE 414. The client device 404 includes an IDE 416. Also, each IDE includes an instantiation of one or more projects. In this example, the IDE 412 includes an instantiation of two projects that are both associated with a developer A—a project 422 and a project 423. The IDE 414 includes an instantiation of a project 424 associated with a developer B. The IDE 416 includes an instantiation of a project 426 associated with a developer N. The IDEs 412, 414,416 can include tools (not shown) similar to the IDE 104 depicted in FIGS. 1-2. Also not shown, the IDEs 412, 414, 416 include a data storage manager to allow for access of data from a storage device within the IDE (as described above).

In this example, a developer A is developing code for the project 422 and the project 423 in the IDE 412 on the client device 402. A developer B is developing code for the project 424 in the IDE 414 on the client device 403. A developer N is developing code for the project 426 in the IDE 416 on the client device 404.

Similar to the operations depicted in FIG. 1, a data storage 460 is allocated from developer A's pool of storage 450 for storing data related to the project 422. A data storage 461 is allocated from developer A's pool of storage 450 for storing data related to the project 423. A data storage 462 is allocated from developer B's pool of storage 451 for storing data related to the project 424. A data storage 463 is allocated from developer N's pool of storage 452 for storing data related to the project 426.

Similar to the operations depicted in FIG. 1, the storage controllers validate the credential(s) of the developers prior to allocating a portion of the developer's pool of storage. As described above, data stored in the data storage can include source code created by the developer using a source code editor, debug output from a debugger during debug operations of the source code, assemblies, database diagrams, etc.

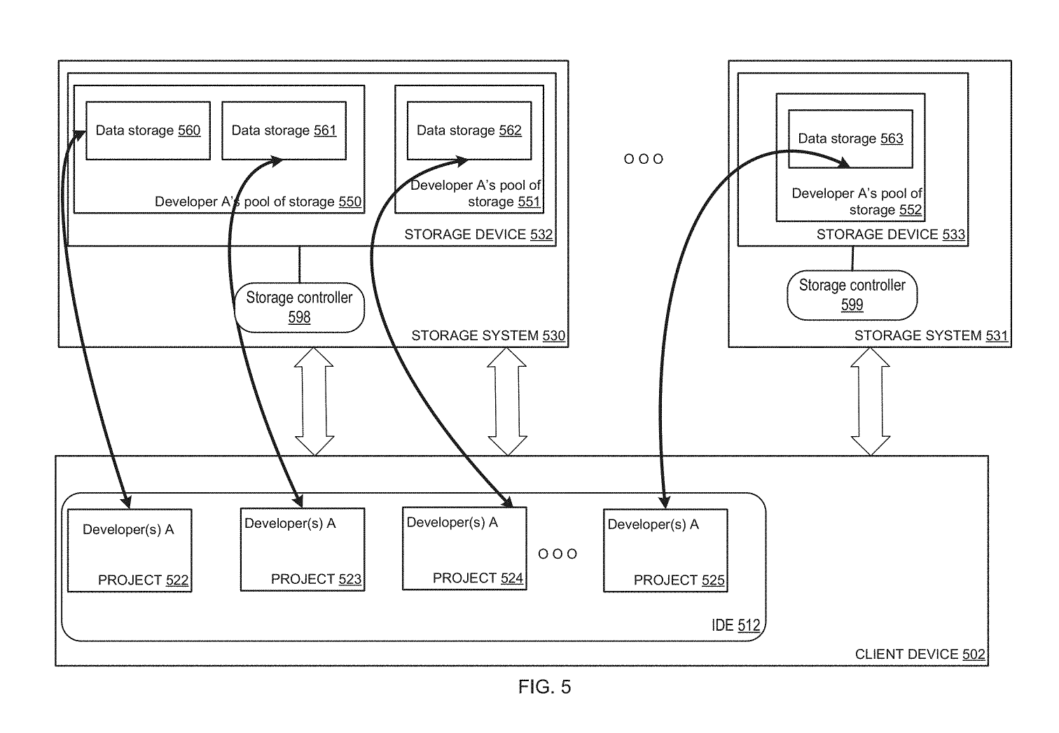

FIG. 5 depicts an example system illustrating one developer having multiple projects stored in different pools of storages associated with the developer, according to some embodiments. Additionally, in this example, the system includes multiple storage systems. For example, one storage system can be cloud-based storage, while another storage system can be NAS. The system includes a client device 502 that is communicatively coupled to a storage system 530 and a storage system 531.

The storage system 530 includes a storage controller 598 that accesses data from a storage device 532. The storage system 531 includes a storage controller 599 that accesses data from a storage device 533. The storage device 532 includes multiple pools of storage that have been previously allocated to developer A (developer A's pool of storage 550 and developer A's pool of storage 551). The storage device 533 includes a pool of storage that also has been previously allocated to developer A (developer A's pool of storage 552).

The client device 502 includes an instantiation of an IDE 512. In this example, the IDE 512 includes instantiations of four different projects associated with the developer A—a project 522, a project 523, a project 524, and a project 525. The IDE 512 can include tools (not shown) similar to the IDE 104 depicted in FIGS. 1-2. Also not shown, the IDE 512 includes a data storage manager to allow for access of data from a storage device within the IDE (as described above).

In this example, a developer A develops code across four different projects. Similar to the operations depicted in FIG. 1, a data storage 560 is allocated from developer A's pool of storage 550 for storing data related to the project 522. A data storage 561 is allocated from developer A's pool of storage 550 for storing data related to the project 523. A data storage 562 is allocated from developer A's pool of storage 551 for storing data related to the project 524. A data storage 563 is allocated from developer A's pool of storage 552 for storing data related to the project 525.

The data storage manager in the IDE 512 can select from which of the number of pools of storage assigned to developer A to allocate a particular project based any of a number of criteria. For example, the selection can be based on developer A's preference (e.g., cloud over local storage). In some implementations, the selection can be based on available storage in the pools of storage. In some examples, a group of developers (not just developer A) is associated with the projects (see description of FIG. 3 above). In these examples, selection can be based on location of the different storage devices relative to the developers. For example, if the developers are geographically dispersed, a cloud-based storage may be selected instead of a file server or some type of local storage.

Also, each of the projects can have their own artifacts. However, at least some of the tools and assets can be shared across projects for those using the same tools or assets. For example, assume that the project 522 and the project 524 use a same version of a compiler. Thus, this same compiler can be shared in the IDE 512 across both projects 522-524.

### Example Operations

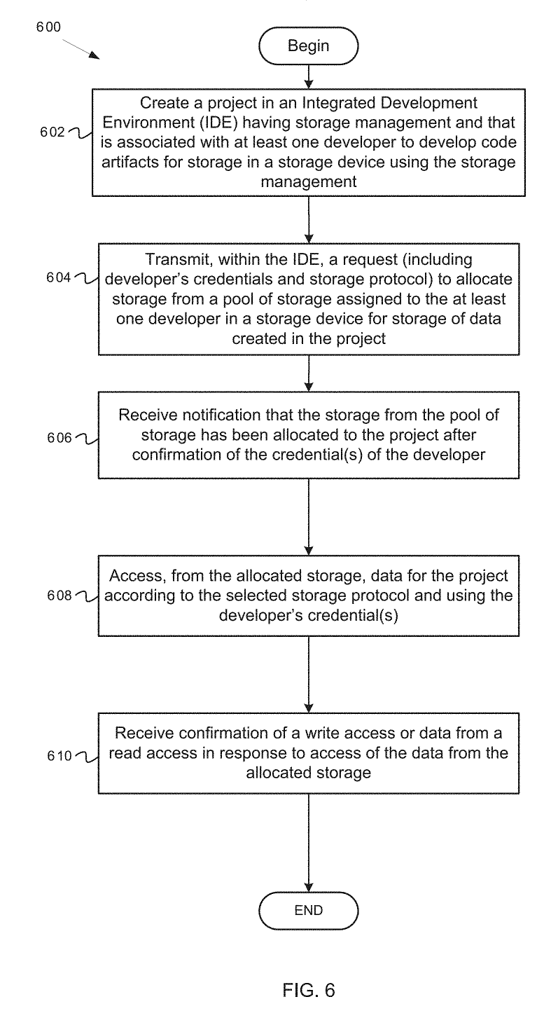

FIG. 6 depicts a flowchart of operations for storage management within an IDE, according to some embodiments. A flowchart 600 is described with reference to FIGS. 1-2. Operations of the flowchart 600 can be performed by software, firmware, hardware or a combination thereof (see for example the data storage manager 116 in the IDE 104 depicted in FIGS. 1-2). The operations of the flowchart 600 start at block 602.

At block 602, a project is created in an IDE that includes storage management. The project is associated with at least one developer to develop code artifacts for storage in a storage device using the storage management. With reference to the example in FIG. 1, the developer A using the client device 102 can input a request to the IDE 104 to create a project having a project type that provides storage management. In this example, the project 106 is created and includes the data storage manager 116 to provide storage management within the IDE 104.

At block 604, a request is transmitted from within the IDE to allocate storage from a pool of storage assigned to the at least one developer in a storage device. The allocated storage is to be used to store data related to the project created in the IDE. The request can include the credential(s) of the at least one developer and the storage protocol that is to be used when accessing data from the allocated storage. With reference to the example in FIG. 1, the developer A using the client device 102 can input their username and password to enable access to their pool of storage. The developer A can also include the type of storage protocol to be used when accessing their pool of storage. The request can also include an identification of the project so that the allocated storage is associated with the project. The storage manager of the IDE can determine available storage from configuration information. The configuration information may be defined in a file read by the storage manager or defined by a user of the IDE. With the configuration information (e.g., identifiers/addresses and storage/communication protocol for the available storage), the storage manager can discover attributes of the available storage (e.g., available capacity, permissions, type of storage media, latency, cost of storage, cost of service, etc.). With information about the available storage, the storage manager can for the storage allocation request based, at least partly, on the discovered information about the storage. For instance, the storage manager can evaluate the discovered information about the available storage against attributes of the project. As previously mentioned, the storage manager can form a storage allocation request for cloud storage based on the project being a geographically distributed project. The storage manager can form the request for storage with a minimum level of encryption and a particular communication protocol based on a project attribute specifying a security level. The storage manager form different requests for different aspects of storage. For example, the storage manager can determine from project attributes that output from testing should be accessible to a specified group of tests. The storage manager can then request cloud storage having a service level agreement that satisfies project specifications and request storage at a specific site associated with the test group.

At block 606, notification is received that at least some of the storage from the pool of storage has been allocated to the project after the credential(s) of the at least one developer is confirmed. With reference to the example in FIG. 1, in response to the request, the storage controller 122 validates the credential(s) of developer A. The storage controller 122 then allocates data storage 152 from the developer A's pool of storage 150 to store data related to the project 106.

At block 608, data is accessed from the storage allocated to the project according to the storage protocol and using the at least one developer's credential(s). Access of data can be a read or write. With reference to the example in FIG. 1, this transmission can include identification of the project 106. Thus, the storage controller 122 can locate the data storage 152 based on the identification of the project 106. The storage controller 122 can then access (read or write) the data in the data storage 152. If the access is a read request, the storage controller 122 can retrieve the data from the data storage 152. With different elements requesting access to data storage and possibly different storage, the storage manager maintains data for tracking requests and properly routing responses. The storage manager can maintain an indexing structure of requests indexed by an identifier of the requesting element. When an IDE element requests data access, the storage manager generates an identifier for the request (e.g., timestamp and request type). The storage manager creates an entry in the indexing structure with the request identifier and a requestor identifier. For example, the storage manager can create an entry for a compiler requesting a write of compiler output to one of multiple storage allocated to the IDE.

At block 610, in response to access the data from the storage, for a write access, a confirmation of the write is received. For a read access, data from the read is received. With reference to the example in FIG. 1, the storage controller 122 returns (back to the data storage manager 116) either a confirmation that the write access was correctly performed or the data from a read access. The data storage manager 116 can then provide the confirmation or data to the tool in the IDE 104 that originated the access request. The storage manager can determine a type of the corresponding request and a time of the corresponding request from a header or metadata of the response. With the time stamp and the access type, the storage manager can identify the IDE element (e.g., compiler, editor, etc.) with the indexing structure and provide the requested data or access confirmation to the identified IDE element.

Operations at blocks 608-610 can continue as additional access requests are received by the data storage manager 116 in the IDE 104. As described above, there can be multiple projects in a same IDE and/or a same project shared by multiple developers having their own instantiation of an IDE. Operations for creating a project, allocating storage for the project from within the IDE and accessing data stored in the allocated storage as described in FIG. 6 can be similarly performed for these additional implementations.

### Example Computer Device

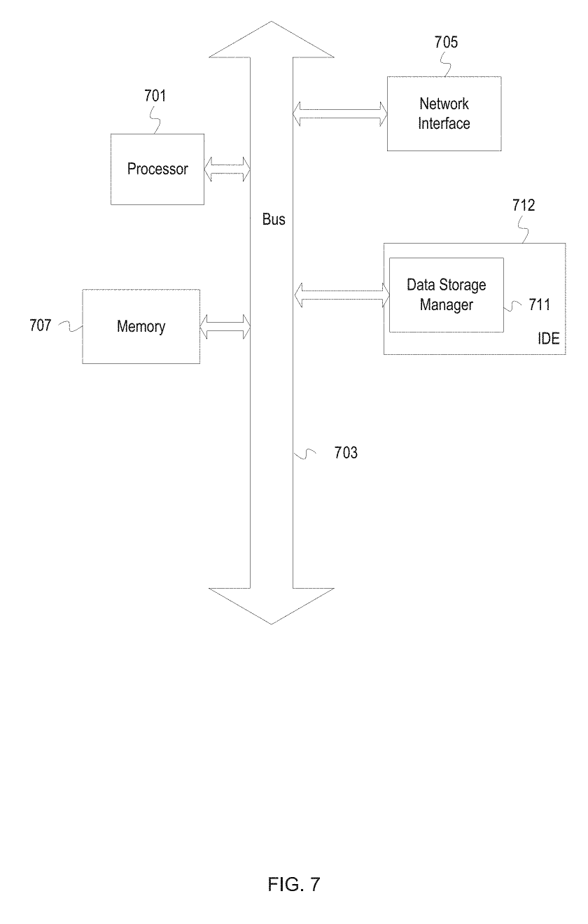

FIG. 7 depicts an example computer device, according to some embodiments. The computer device includes a processor 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system communicates via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The system also includes a data storage manager 711 that is executing in an IDE 712. The data storage manager 711 allocates storage for storing data related to code development in a project in the IDE 712 (as described above). Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operation(s) represented by block 411 may not be performed. A rebuild node may not prioritize rebuild of objects within a range and concurrently request rebuild for all of the at risk objects within the object range. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in machine-readable medium(s). Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as fragment of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for background risk assessment to drive object rebuild as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
creating a project in an Integrated Development Environment (IDE) having storage management, wherein the project is associated with at least one developer to develop code artifacts in the project;
requesting, using the storage management of the IDE, allocation of storage for data created in the project during the development of the code artifacts by a plurality of tools of the IDE; and
maintaining tracking data within the IDE that tracks a plurality of storage related requests by the plurality of tools of the IDE.

2. The method of claim 1, wherein the storage is allocated from a pool of storage assigned to the at least one developer.

3. The method of claim 2, wherein requesting allocation of storage comprises:
transmitting a request that comprises a credential of the at least one developer and a storage protocol to be used for access of the storage from the IDE.

4. The method of claim 3, further comprising:
receiving notification that the storage is allocated after confirmation of the credential of the at least one developer.

5. The method of claim 1, further comprising:
identifying, for a storage related request of the plurality of storage related requests, which tool of the plurality of tools made the storage related request; and
supplying a confirmation response to the storage related request to the tool.

6. The method of claim 5, wherein maintaining the tracking data comprises updating the tracking data with an identifier of the tool and an indication of the storage related request based, at least in part, on the tool making a data access request from the storage.

7. The method of claim 1, wherein the at least one developer comprises a group of developers and wherein the storage is allocated from a pool of storage in a storage device that comprises a cloud-based storage device.

8. The method of claim 1, wherein the storage is allocated from a pool of storage in a storage device that comprises a flash disk array.

9. A non-transitory machine readable medium having stored thereon instructions for performing a method comprising machine executable code which when executed by at least one machine, causes the at least one machine to:
create a project in an Integrated Development Environment (IDE) having storage management, wherein the project is associated with at least one developer to develop code artifacts in the project;
request, using the storage management of the IDE, allocation of storage for data created in the project during the development of the code artifacts by a plurality of tools of the IDE; and
maintain tracking data within the IDE that tracks a plurality of storage related requests by the plurality of tools of the IDE.

10. The non-transitory machine readable medium of claim 9, wherein the storage is allocated from a pool of storage assigned to the at least one developer.

11. The non-transitory machine readable medium of claim 10, wherein the machine executable code which when executed by at least one machine, causes the at least one machine to request allocation of storage comprises machine executable code which when executed by at least one machine, causes the at least one machine to:
transmit a request that comprises a credential of the at least one developer and a storage protocol to be used for access of the storage from the IDE.

12. The non-transitory machine readable medium of claim 11, wherein the machine executable code comprises machine executable code which when executed by at least one machine, causes the at least one machine to:
receive notification that the storage is allocated after confirmation of the credential of the at least one developer.

13. The non-transitory machine readable medium of claim 9, wherein the machine executable code comprises machine executable code which when executed by at least one machine, causes the at least one machine to:
identify, for a storage related request of the plurality of storage related requests, which tool of the plurality of tools made the storage related request; and
supply a confirmation response to the storage related request to the tool.

14. The non-transitory machine readable medium of claim 13, wherein the machine executable code which when executed by at least one machine, causes the at least one machine to maintain the tracking data comprises machine executable code which when executed by at least one machine, causes the at least one machine to update the tracking data with an identifier of the tool and an indication of the storage related request based, at least in part, on the tool making a data access request from the storage.

15. A computing device comprising:
a processor; and
a machine readable medium comprising machine executable code having stored thereon instructions executable by the processor to cause the computing device to:
receive selection of a project type in an Integrated Development Environment (IDE) that includes storage management;
create a project in the IDE based on the project type, wherein the project is associated with at least one developer to develop code artifacts in the project; and
allocate, using the storage management in the IDE, storage in a storage device to store data created in the project during the development of the code artifacts, wherein the machine executable code having stored thereon instructions executable by the processor to cause the computing device to allocate comprises machine executable code having stored thereon instructions executable by the processor to cause the computing device to,
transmit, from the IDE using the storage management to a storage controller of the storage device, a request to allocate at least a portion of a pool of storage assigned to the at least one developer to the storage for the project, wherein the request comprises a credential of the at least one developer and a storage protocol to be used for storage in the at least the portion; and
receive, from the storage controller, notification that the least the portion is allocated for the project after confirmation of the credential of the at least one developer.

16. The computing device of claim 15, wherein the machine executable code comprises machine executable code having stored thereon instructions executable by the processor to cause the computing device to:
generate the code artifacts in the project using a source code editor in the IDE;
transmit, based at least in part on the storage protocol and using the storage management in the IDE, the code artifacts and the credential of the at least one developer to the storage device for storage of the code artifacts in the storage device; and
receive, from the storage controller, notification that the code artifacts are stored in the at least the portion of the pool of storage after confirmation of the credential.

17. The computing device of claim 15, wherein the at least one developer comprises a first developer and a second developer, wherein the code artifacts comprise source code that were created by the first developer, wherein the machine executable code comprises machine executable code having stored thereon instructions executable by the processor to cause the computing device to:
retrieve, using the storage management in the IDE for the second developer, the source code from the at least the portion of the pool of storage;
debug, using a debugger in the IDE, the source code to generate a debug output;
transmit, based at least in part on the storage protocol and using the storage management in the IDE, the debug output and the credential to the storage device for storage of the source code in the at least the portion of the pool of storage; and
receive, from the storage controller, notification that the debug output is stored in the at least the portion of the pool of storage after confirmation of the credential.

18. The computing device of claim 15, wherein the code artifacts comprise source code, wherein the machine executable code comprises machine executable code having stored thereon instructions executable by the processor to cause the computing device to:
compile, in the IDE, the source code to generate an executable;
transmit, based at least in part on the storage protocol and using the storage management in the IDE, the executable and the credential for storage of executable in the at least the portion of the pool of storage; and
receive, from the storage controller, notification that the executable is stored in the at least the portion of the pool of storage after confirmation of the credential.

19. The computing device of claim 15, wherein the at least one developer comprises a first developer and a second developer, wherein the code artifacts comprise source code that were created by the first developer, wherein the machine executable code comprises machine executable code having stored thereon instructions executable by the processor to cause the computing device to:
retrieve, using the storage management in the IDE for the second developer, the source code from the at least the portion of the pool of storage;
modify, using a source code editor in the IDE, the source code to generate a modified source code;
transmit, based at least in part on the storage protocol and using the storage management in the IDE, the modified source code and the credential to the storage device for storage of the modified source code in the at least the portion of the pool of storage; and
receive, from the storage controller, notification that the modified source code is stored in the at least the portion of the pool of storage after confirmation of the credential.

20. The computing device of claim 15, wherein the at least one developer comprises a group of developers and wherein the storage device comprises a cloud-based storage device.
